(19) United States
(12) Patent Application Publication
(10) Pub. No.: US 2021/0351580 A1
(43) Pub. Date: Nov. 11, 2021

(54) POWER ADAPTER AND ELECTRONIC DEVICE

(71) Applicant: Consumer HK Holdco II Limited, Hong Kong (HK)

(72) Inventor: SP Fan, Shen Zhen (CN)

(21) Appl. No.: 16/904,011

(22) Filed: Jun. 17, 2020

(30) Foreign Application Priority Data
May 11, 2020 (CN) 202010392488.2

(51) Int. Cl. H02H 3/05; H02H 3/20

(52) U.S. Cl. CPC H02H 3/05; H02H 3/20

(57) ABSTRACT

Embodiments of the present disclosure provides a power adapter and an electronic device. The power adapter includes a voltage conversion circuit and at least one overvoltage protection circuit. The voltage conversion circuit is configured to perform a conversion operation on a voltage inputted via the input terminal and then output a DC voltage from the at least one output terminal, where the DC voltages outputted from at least two output terminals have different levels. The overvoltage protection circuit includes a voltage dividing unit, a first voltage stabilizing unit and a switch. The overvoltage protection circuit is configured such that, when the voltage divided and subsequently outputted by the voltage dividing unit is greater than a setting voltage, the first voltage stabilizing unit controls the switch to be turned on to output a control signal through the switch to the voltage conversion circuit, in order to control the at least one output terminal of the voltage conversion circuit to stop an outputting operation The present disclosure can achieve the overvoltage protection, simplify the circuit configuration, reduce the design costs, enable the overvoltage protection to be accurate and adjustable, and improve the safety of the power adapter.

### TECHNICAL FIELD

Embodiments of the present disclosure relate to switch power supply technologies, and in particular, to a power adapter and an electronic device.

### TECHNICAL BACKGROUND

A power adapter is a type of a power supply for an electric energy conversion, which is capable of converting standard alternate-current (AC) into regulated direct-current (DC), to supply power for electronic devices such as a television or a computer. The power adapter may have an overvoltage phenomenon, and hence an overvoltage protection is required to prevent the electronic device being damaged.

In the prior art, the overvoltage protection for the power adapter are generally performed by employing an optical coupler or a primary-side voltage detection. In the scheme that the optical coupler is used for the overvoltage protection, a response speed and a control precision can be ensured, but an optical coupler and a respective control circuit are required to be additionally provided in each of outputs of the power adapter, thus greatly increasing the design costs. In the scheme that the primary-side voltage detection is used for the overvoltage protection, since various parameters on the primary-side would be changed, this would cause a range of the overvoltage protection to be too large, making it difficult to ensure an accuracy of the overvoltage protection.

### SUMMARY OF THE DISCLOSURE

Embodiments of the present disclosure provide a power adapter and an electronic device, so as to achieve the overvoltage protection, simplify the circuit structure, reduce the design costs, ensure the accuracy of the overvoltage protection, and improve security of the power adapter.

In a first aspect, an embodiment of the present disclosure provides a power adapter. The power adapter includes: a voltage conversion circuit including an input terminal and at least two output terminals. The voltage conversion circuit is configured to perform a conversion operation on a voltage inputted via the input terminal and then output a direct-current (DC) voltage from the at least two output terminals, where the DC voltages outputted from at least two output terminals have different levels. The power adapter further includes at least one overvoltage protection circuit, including a voltage dividing unit, a first voltage stabilizing unit and a switch. The voltage dividing unit is connected between a first output terminal of the at least two output terminals of the voltage conversion circuit and the first voltage stabilizing unit, and the first voltage stabilizing unit is connected to the switch. The overvoltage protection circuit is configured such that, when the voltage divided and subsequently outputted by the voltage dividing unit is greater than a setting voltage, the first voltage stabilizing unit controls the switch to be turned on to output a control signal through the switch to the voltage conversion circuit, in order to control the first output terminal of the at least two output terminals of the voltage conversion circuit to stop an outputting operation.

Optionally, the voltage conversion circuit comprises a main loop circuit and a first control loop circuit. The main loop circuit is connected between the input terminal and the at least two output terminals of the voltage conversion circuit. The first control loop circuit is connected between the main loop circuit and a second output terminal of the at least two output terminals of the voltage conversion circuit. A first optical coupler is connected in series on the first control loop circuit. The switch is connected to an input terminal of the first optical coupler, and the switch controls via the first optical coupler whether the main loop circuit stops the outputting operation, wherein the first output terminal and the second output terminal may be same output terminal or different output terminals.

Optionally, the voltage conversion circuit further includes a second control loop circuit. The second control loop circuit is connected between the main loop circuit and a starting switch, a second optical coupler is serially connected on the second control loop circuit, the switch is connected to an input terminal of the second optical coupler, and the switch controls via the second optical coupler whether the main loop circuit stops the outputting operation.

Optionally, the first control loop circuit further includes a first control chip and a second voltage stabilizing unit. The first control chip is connected between the main loop circuit and the first optical coupler, the second voltage stabilizing unit is connected between the first optical coupler and the second output terminal of the at least two output terminals of the voltage conversion circuit, and the first optical coupler controls via the first control chip whether the main loop circuit stops the outputting operation. The second voltage stabilizing unit is configured to control via the first optical coupler and the first control chip whether the main loop circuit stops the outputting operation, when the voltage outputted from the output terminal of the voltage conversion circuit is unstable.

Optionally, the second voltage stabilizing unit includes a first current-limiting resistor, a second current-limiting resistor, a first voltage stabilizer, a loop circuit compensator, a first voltage dividing resistor, a second voltage dividing resistor and an output voltage regulator. The first current-limiting resistor and the second current-limiting resistor are sequentially connected in series between the second output terminal of the at least two output terminals of the voltage conversion circuit and a first terminal of the first voltage stabilizer, an input terminal of the first optical coupler is connected between the first current-limiting resistor and the second current-limiting resistor, another input terminal of the first optical coupler is connected between the second current-limiting resistor and the first terminal of the first voltage stabilizer, a loop circuit compensator is connected between the first terminal of the first voltage stabilizer and a reference terminal of the first voltage stabilizer, the first voltage dividing resistor and the second voltage dividing resistor are sequentially connected in series between the second output terminal of the at least two output terminals of the voltage conversion circuit and a second terminal of the first voltage stabilizer, the reference terminal of the first voltage stabilizer is connected to between the first voltage dividing resistor and the second voltage dividing resistor, the second terminal of the first voltage stabilizer is grounded, and the output voltage regulator is connected in parallel to the first voltage dividing resistor.

Optionally, the second control loop circuit further includes a second control chip, a third current-limiting resistor and the third voltage dividing resistor. The second control chip is connected between the main loop circuit and the second optical coupler, and the third current-limiting resistor is connected in series between the starting switch and an input terminal of the second optical coupler, the third voltage dividing resistor connected in parallel between the two input terminals of the second optical coupler, and the second optical coupler controls via the second control chip whether the main loop circuit stops the outputting operation.

Optionally, the voltage dividing unit includes a fourth voltage dividing resistor and a fifth voltage dividing resistor, and the first voltage stabilizing unit includes a voltage stabilizer diode. The fourth voltage dividing resistor and the fifth voltage dividing resistor are sequentially connected in series between the first output terminal of the at least two output terminals of the voltage conversion circuit and a second terminal of the switch, a terminal of the voltage stabilizer diode is connected between the fourth voltage dividing resistor and the fifth voltage dividing resistor, another terminal of the voltage stabilizer diode is connected to a control terminal of the switch, the first terminal of the switch is connected to the one of the two input terminals of the first optical coupler and/or the one of the two input terminals of the second optical coupler, and a second terminal of the switch is grounded.

Optionally, the overvoltage protection circuit further includes a fourth current-limiting resistor and a first protective resistor. The fourth current-limiting resistor is connected between the voltage stabilizer diode and the control terminal of the switch, and the first protective resistor is connected in series between the voltage stabilizer diode and the second terminal of the switch.

Optionally, the voltage conversion circuit includes three output terminals, the three output terminals output different levels of the DC voltages from each other, and when the at least one overvoltage protection circuit comprises one overvoltage protection circuit, the one overvoltage protection circuit is connected to any one of the three output terminals, and when the at least one overvoltage protection circuit comprises a plurality of overvoltage protection circuits, the plurality of overvoltage protection circuit are connected to more of the three output terminals in a one-to-one correspondence, respectively.

In a second aspect, an embodiment further provide an electronic device, which is powered by the power adapter in the first aspect.

An embodiment of the present disclosure provides a power adapter and an electronic device. The power adapter includes a voltage conversion circuit and at least one overvoltage protection circuit. The voltage conversion circuit includes an input terminal and at least one output terminal, where the voltage conversion circuit is configured to perform a conversion operation on a voltage inputted via the input terminal and then output a DC voltage from the at least one output terminal, where the DC voltages outputted from at least two output terminals have different levels; and the at least one overvoltage protection circuit includes a voltage dividing unit, a first voltage stabilizing unit and a switch, where the voltage dividing unit is connected between the at least output terminal of the voltage conversion circuit and the first voltage stabilizing unit, and the first voltage stabilizing unit is connected to the switch. The overvoltage protection circuit is configured such that, when the voltage divided and subsequently outputted by the voltage dividing unit is greater than a setting voltage, the first voltage stabilizing unit controls the switch to be turned on to output a control signal through the switch to the voltage conversion circuit, in order to control the at least one output terminal of the voltage conversion circuit to stop an outputting operation. According to the present embodiment, there is no need to additionally provide the overvoltage protection circuit with an optical coupler and a control device thereof, but instead, the setting voltage can be set in accordance with the voltage levels of the output terminals, so that an accurate voltage sampling can be made by the voltage dividing unit, thereby alleviating the problem of increase in the design costs and low accuracy in the overvoltage protection in the prior art, and hence achieving the overvoltage protection, simplifying the circuit configuration, reducing the design costs, enabling the overvoltage protection to be accurate and adjustable, and improving the safety of the power adapter.

### DESCRIPTION OF DRAWINGS

FIG. 1 is a schematic diagram of block configurations of a power adapter according to an embodiment of the present disclosure;

FIG. 2 is a schematic diagram of block configurations of another power adapter according to an embodiment of the present disclosure;

FIG. 3 is a schematic diagram of circuit configurations of another power adapter according to an embodiment of the present disclosure;

FIG. 4 is a schematic diagram of circuit configurations of the first control loop circuit 12 in FIG. 3;

FIG. 5 is a schematic diagram of circuit configurations of the second control loop circuit 13 in FIG. 3;

FIG. 6 is a schematic diagram of circuit configurations of the overvoltage protection circuit 30 in FIG. 3;

FIG. 7 is a schematic diagram of circuit configurations of another power adapter according to an embodiment of the present disclosure;

FIG. 8 is a schematic diagram of circuit configurations of the second rectifier unit 115 in FIG. 7;

FIG. 9 is a schematic diagram of circuit configurations of the third rectifier unit 114 in FIG. 7; and

FIG. 10 is a schematic diagram of block configurations of an electronic device according to an embodiment of the present disclosure.

### DETAILED DESCRIPTION OF THE PREFERRED EMBODIMENTS

The present disclosure will be further described in detail below with reference to accompany drawings and embodiments. It should be understood that the specific embodiments described herein are only used for explaining, rather than limiting, the present disclosure. In addition, it should be noted that, in order to facilitate description, the drawings only show parts of but not all of structures related to the present disclosure.

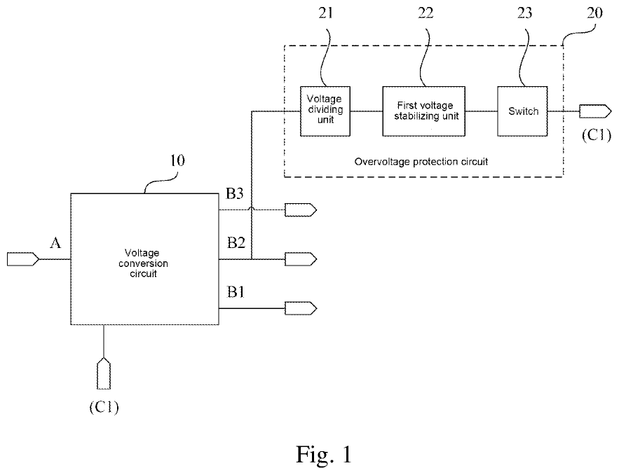

FIG. 1 is a schematic diagram of block configurations of a power adapter according to an embodiment of the present disclosure. As shown in FIG. 1, the power adapter includes a voltage conversion circuit 10 and at least one overvoltage protection circuit 20. The voltage conversion circuit 10 includes an input terminal A and at least one output terminal. The voltage conversion circuit 10 is configured to perform a conversion operation on a voltage inputted via the input terminal A and then output a DC voltage from the at least one output terminal. The overvoltage protection circuit 20 includes a voltage dividing unit 21, a first voltage stabilizing unit 22 and a switch 23. The voltage dividing unit 21 is connected between an output terminal of the voltage conversion circuit 10 and the first voltage stabilizing unit 22. The first voltage stabilizing unit 22 is connected to the switch 23. The overvoltage protection circuit 20 is configured such that when the voltage divided and subsequently outputted by the voltage dividing unit 21 is greater than a setting voltage, the first voltage stabilizing unit 22 controls the switch 23 to be turned on. After the switch 23 is turned on, a control signal C1 is outputted to the voltage conversion circuit 10, in order to control the output terminal of the voltage conversion circuit 10 to stop an outputting operation.

FIG. 1 schematically shows a case where the voltage conversion circuit 10 includes three output terminals, namely a first output terminal B1, a second output terminal B2, and a third output terminal B3. As shown in FIG. 1, specifically, the power adapter is capable of converting electrical energy inputted via the input terminal A of the voltage conversion circuit 10 into DC voltages with different levels, and then output the DC voltages with different levels from the first output terminal B1, the second output terminal B2 and the third output terminal B3, respectively, in order to supply the power to an electronic device. The electric energy inputted via the input terminal A of the voltage conversion circuit 10 may be alternating current. Accordingly, the voltage conversion circuit 10 may include an inverter, a transformer, a rectifier and other structures to achieve the conversion for the electric energy.

Referring to FIG. 1, the setting voltage may be set according to the output terminal of the voltage conversion circuit 10 corresponding to the overvoltage protection circuit 20. Specifically, the setting voltage may be adjusted by setting parameters of components in the voltage dividing unit 21. The overvoltage protection circuit 20 can sample the output voltage outputted from any of the output terminals of the conversion circuit 10, so as to determine whether there is an overvoltage based on the relationship between the sampled voltage value and the setting voltage value. For example, the voltage dividing unit 21 may sample the output voltage at the second output terminal B2, and if the output voltage at the second output terminal B2 is greater than the setting voltage, the first voltage stabilizing unit 22 electrically connects the voltage dividing unit 21 to the switch 23, such that the switch 23 is turned on. Once the switch 23 is turned on, the control signal C1 outputted to the voltage conversion circuit 10 will be changed, so that a control circuit inside the voltage conversion circuit 10 may control the voltage conversion circuit 10 to stop the conversion on the electric energy inputted by the input terminal A according to the change in the received control signal C1, so as to enable the voltage conversion circuit 10 stops outputting the voltage, thereby preventing the electronic device from being damaged due to too large voltage outputted to the electronic device voltage from the power adapter.

In the prior art, the overvoltage protection of the power adapter generally is performed in such a manner that each of the outputs by the power adapter requires to be additionally provided with an optical coupler and the respective control circuit, or by using a primary-side voltage detection. However, the scheme of providing the optical coupler and the control circuit would increase the design costs, and the use of the primary-side voltage detection would lower the overvoltage protection accuracy. With the power adapter according to the embodiments of the present disclosure, the voltage dividing unit can sample the output voltage at the voltage conversion circuit. If an overvoltage is detected in the output voltage, the first voltage stabilizing unit can control the switch to be turned on to output the control signal through the switch to the voltage conversion circuit, in order to control the voltage conversion circuit to stop outputting the voltage. According to the present embodiment, there is no need to additionally provide the overvoltage protection circuit with an optical coupler and a control device, but instead, the setting voltage can be set in accordance with the voltage levels of the output terminals, so that an accurate voltage sampling can be made by the voltage dividing unit, thereby alleviating the problem of increase in the design costs and low accuracy in the overvoltage protection in the prior art, and hence achieving the overvoltage protection, simplifying the circuit configuration reducing the design costs, enabling the overvoltage protection to be accurate and adjustable, and improving the safety of the power adapter.

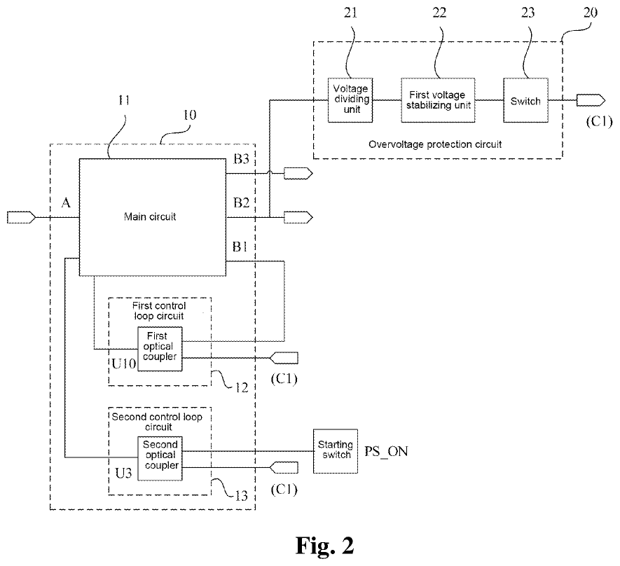

FIG. 2 is schematic diagram of block configurations of another power adapter according to an embodiment of the present disclosure. As shown in FIG. 2, optionally, the voltage conversion circuit 10 includes a main loop circuit 11 and a first control loop circuit 12. The main loop circuit 11 is connected between the input terminal A and the output terminals of the voltage conversion circuit 10. The first control loop circuit 12 is connected between the main loop circuit 11 and an output terminal of the voltage conversion circuit 10. A first optical coupler U10 is connected in series on the first control loop circuit 12. The switch 23 is connected to an input terminal of the first optical coupler U10. The switch 23 controls via the first optical coupler U10 whether the main loop circuit 11 stops the outputting operation.

Referring to FIG. 2, the main loop circuit 11 can convert the AC inputted via the input terminal A to DCs with different voltage levels, and output DCs with different voltage levels from the first output terminal B 1, the second output terminal B2, and the third output terminal B3, respectively. The main loop circuit 11 may include structural forms of a rectifier circuit and a DC-DC circuit. The first control loop circuit 12 may control the power conversion of the main loop circuit 11. For example, the first control loop circuit 12 may include a control chip capable of outputting a PWM signal. The first optical coupler U10 includes a light emitter and a light receiver. When an electrical signal is inputted to the first optical coupler U10, the loop circuit where the light emitter is located is energized, the light emitter emits light, the light is received by the light receiver to generate an optical current, and then the optical current is outputted from an output terminal of the first optical couple U10 so that the U10 is turned on, to achieve “electrical-optical-electrical” conversion for the signal. Exemplarily, when the overvoltage protection circuit detects the overvoltage at the second output terminal B2, the switch 23 can output the control signal C1 to an input terminal of the first optical coupler U10, to control the first optical coupler U10 to be turned on. Then, The first control loop circuit 12 outputs the control signal to the main loop circuit 11 according to turning-on of the first optical coupler U10. The main loop circuit 11 can stop outputting the voltage according to the received control signal, in order to achieve overvoltage protection. It should be understood that, the control signal outputted via the switch 23 may be a high-level signal or a low-level signal, which is not limited herein, as long as the first optical coupler U10 can be controlled.

Still referring to FIG. 2, optionally, the voltage conversion circuit 10 further includes a second control loop circuit 13. The second control loop circuit 13 is connected between the main loop circuit 11 and a starting switch PS_ON. A second optical coupler U3 is connected in series on the second control loop circuit 13. The switch 23 is connected to an input terminal of the second optical coupler U3. The switch 23 controls via the second optical coupler U3 whether the main loop circuit 11 stops the outputting operation.

Specifically, referring to FIG. 2, the starting switch PS_ON can directly control whether the main loop circuit 11 performs the power conversion through the second control loop circuit 13. For example, after the starting switch PS_ON is triggered, the second optical coupler U3 is turned on, so that the second control circuit 13 controls the main loop circuit 11 to perform the power conversion according to turning-on of the second optical coupler U3. When the overvoltage protection circuit 20 detects an overvoltage at the second output terminal B2 of the voltage conversion circuit 10, the switch 23 may also output the control signal C1 to an input terminal of the second optical coupler U3, to control the second optical coupler U3 to be turned off. Then, the second control loop circuit 13 controls the main loop circuit 11 to stop outputting voltage according to turning-off of the second optical coupler U3, so as to achieve overvoltage protection. For example, the second control loop circuit 13 may control the main loop circuit 11 to work normally by outputting a driven signal to the main loop circuit 11, so that the second output terminal B2 of the main loop circuit 11 outputs the voltage; and, the second control loop circuit 13 may control the second output terminal B2 of the main loop circuit 11 to stop the outputting operation by stopping outputting the driven signal to the main loop circuit 11.

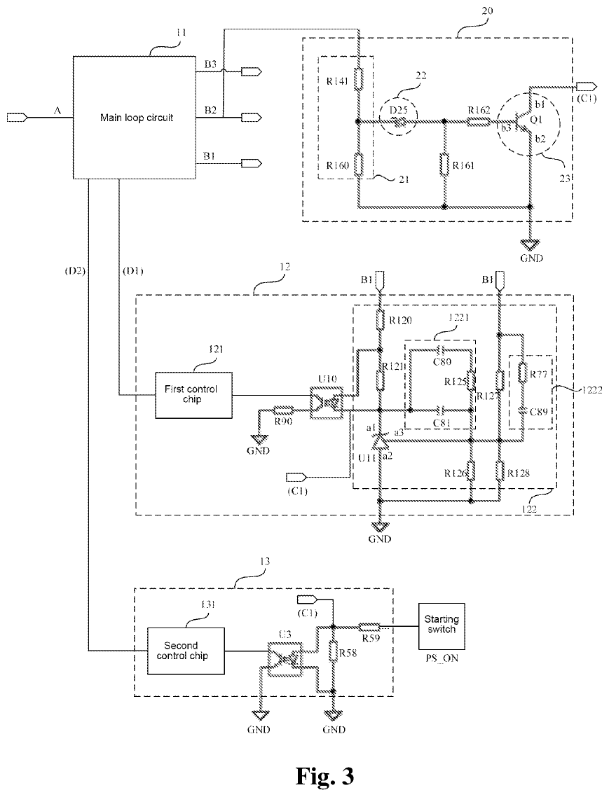

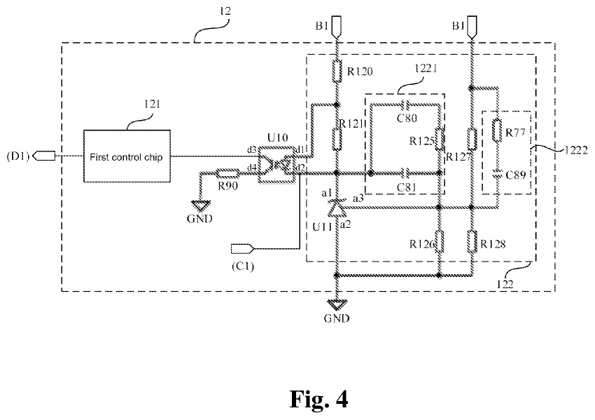

FIG. 3 is a schematic diagram of circuit configurations of another power adapter according to an embodiment of the present disclosure. FIG. 4 is a schematic diagram of circuit configurations of the first control loop circuit 12 in FIG. 3. In conjunction with FIG. 3 and FIG. 4, optionally, the first control loop circuit 12 further includes a first control chip 121 and a second voltage stabilizing unit 122. The first control chip 121 is connected between the main loop circuit 11 and the first optical coupler U10. The second voltage stabilizing unit 122 is connected between the first optical coupler U10 and an output terminal of the voltage conversion circuit 10. The first optical coupler U10 controls via the first control chip 121 whether the main loop circuit 11 stops the outputting operation. The second voltage stabilizing unit 122 is configured to control via the first optical coupler U10 and the first control chip 121 whether the main loop circuit 11 stops the outputting operation, when the voltage outputted from the output terminal of the voltage conversion circuit 10 is unstable.

In conjunction with FIG. 3 and FIG. 4, specifically, the first control chip 121 may control the main loop circuit 11 to convert the power. For example, when the main loop circuit 11 adopts a structure form of a flyback DC-DC circuit, the first control chip 121 may be a flyback control chip. The second voltage stabilizing unit 122 may control the first output terminal B1 of the voltage conversion unit 11 to output a stable power. When an overvoltage occurs at the second output terminal B2 of the voltage conversion unit 11, the overvoltage protection circuit 20 can output the control signal C1 to the second input terminal d2 of the first optical coupler U10. The control signal C1 is a low-level signal for example, thereby pulling down a potential at the second input terminal d2 of the first optical coupler U10, such that a light emitting device of the first optical coupler U10 emits light, and the light receiving device then may be turned on after receiving the light emitted from the light emitting device, i.e., the first optical coupler U10 is turned on, so that a potential at the first output terminal d3 of the first optical coupler U10 is changed, for example, the potential at the second output terminal d3 is pulled down. The first control chip 121 can detect the potential at the first output terminal d3, and output the control signal D1 to the main loop circuit 11 when the potential at the first output terminal d3 is changed, so that the main loop circuit 11 stops outputting the voltage, thereby achieving the overvoltage protection. Furthermore, when detecting the voltage outputted from the first output terminal B1 is unstable, the second voltage stabilizing unit 122 may also change the potential at the second input terminal d2, so that the first control chip 121 controls the main loop circuit 11 to stop outputting the voltage. In such a way, the first control loop circuit 12 can both achieve the overvoltage protection on the second output terminal B2, and hold the first output terminal B1 to output the stable voltage, thereby further improving the safety of the power adapter.

Exemplarily, referring to FIG. 4, the second voltage stabilizing unit 122 includes a first current-limiting resistor R120, a second current-limiting resistor R121, a first voltage stabilizer U11, a loop circuit compensator 1221, a first voltage dividing resistor R127, a second voltage dividing resistor R128 and an output voltage regulator 1222. The first current-limiting resistor R120 and the second current-limiting resistor R121 are sequentially connected in series between an output terminal of the voltage conversion circuit 10 and a first terminal a1 of the first voltage stabilizer U11. An input terminal of the first optical coupler U10 is connected between the first current-limiting resistor R120 and the second current-limiting resistor R121, and another input terminal of the first optical coupler U10 is connected between the second current-limiting resistor R121 and the first terminal a1 of the first voltage stabilizer U11. The loop circuit compensator 1221 is connected between the first terminal a1 and a reference terminal a3 of the first voltage stabilizer U11. The first voltage dividing resistor R127 and the second voltage dividing resistor R128 are sequentially connected in series between an output terminal of the voltage conversion circuit 10 and a second terminal a2 of the first voltage stabilizer U11. The reference terminal a3 of the first voltage stabilizer U11 is connected between the first voltage dividing resistor R127 and the second voltage dividing resistor R128. The second terminal a2 of the first voltage stabilizer U11 is grounded. The output voltage regulator 1222 is connected in parallel with the first voltage dividing resistor R127.

As shown in FIG. 4, specifically, the first current-limiting resistor R120 and the second current-limiting resistor R121 may limit the power which is outputted from the first output terminal B1 to the first optical coupler U10 and the first voltage stabilizer U11. The first voltage stabilizer U11 may be a three-terminal adjustable voltage stabilizer. When the voltage inputted to the reference terminal a3 of the first voltage stabilizer U11 is greater than the reference voltage of the first voltage stabilizer U11, the first voltage stabilizer U11 is turned on reversely, so that the potential at the second input terminal d2 of the first optical coupler U10 is changed, resulting in a change in the conduction state of the first optical coupler U10. The first control chip 121 controls, according to the change in the conduction state of the first optical coupler U10, whether the main loop circuit 11 outputs the voltage. The loop circuit compensator 1221 is configured for lifting response speed of the second voltage stabilizing unit 122. The first voltage dividing resistor R127 and the second voltage dividing resistor R128 is configured for sampling the output voltage at the first output terminal B1 of the main loop circuit. Optionally, a voltage dividing resistor R126 may also be provided, and voltage sampling may be performed through the first voltage dividing resistor R127, the second voltage dividing resistor R128 together with the voltage dividing resistor R126. The output voltage regulator 1222 includes a resistor R77 and a capacitor C89. By using the resistor R77 and the capacitor C89, the output voltage regulator 1222 can function as a voltage buffer to the power which is outputted from the first output terminal B1 to the second voltage stabilizing unit 122, and absorb voltage spikes. Exemplarily, the working principle of the second voltage stabilizing unit 122 is that: the output voltage of the first output terminal B1 is sampled through the first voltage dividing resistor R127, the second voltage dividing resistor R128 and the voltage dividing resistor R126. When output voltage after the voltage division is greater than the reference voltage of the first voltage stabilizer U11, the first voltage stabilizer U11 is turned on reversely to pull down the potential at the second input terminal d2, so that the first optical coupler the U10 outputs a control signal D1 to the main loop circuit 11 through a first control chip 121 to control the main loop circuit 11 to stop outputting the voltage. In this way, a feedback control is formed, thereby ensuring the stability of the output voltage of the first output terminal B1.

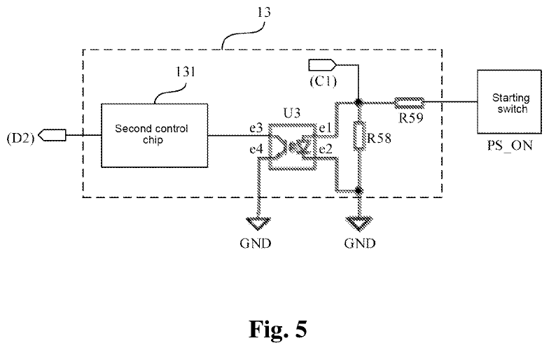

FIG. 5 is a schematic diagram of circuit configurations of the second control loop circuit 13 in FIG. 3. In conjunction with FIG. 3 and FIG. 5, optionally, the second control loop circuit 13 further includes a second control chip 131, a third current-limiting resistor R59 and a third voltage dividing resistor R58. The second control chip 131 is connected between the main loop circuit 11 and the second optical coupler U3. The third current-limiting resistor R59 is connected in series between the starting switch PS_ON and an input terminal of the second optical coupler U3. The third voltage dividing resistor R58 is connected in parallel between the two input terminals of the second optical coupler U3. The second optical coupler U3 controls via the second control chip 131 whether the main loop circuit 11 stops the outputting operation.

In conjunction with FIG. 3 and FIG. 5, specifically, the second control chip 131 may also control the main loop circuit 11 to convert the power. For example, when the main loop circuit 11 includes a configuration such as a rectifying circuit, the second control chip 131 may be a power factor correcting chip. When there is an overvoltage at the second output terminal B2, the overvoltage protection circuit 20 can output a control signal C1 to the first input terminal e1 of the second optical coupler U3, thereby changing the potential at the first input terminal e1, such that a light emitting device of the second optical coupler U3 emits light, and the light receiving device can be turned on after receiving the light emitted from the light emitting device, thereby changing the potential at the first output terminal e3. The second control chip 131 can detect the potential at the first output terminal e3. When the potential at the first output terminal e3 is changed, the second control chip 131 outputs a control signal D2 to the main loop circuit 11, so that the main loop circuit 11 stops outputting the voltage, thereby achieving the overvoltage protection.

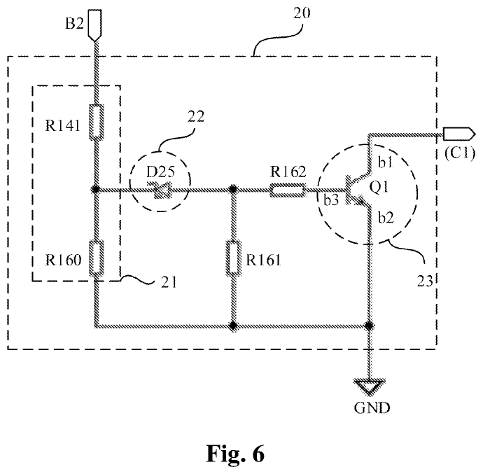

FIG. 6 is a schematic diagram of circuit configurations of the overvoltage protection circuit 30 in FIG. 3. In conjunction with FIGS. 3 and 6, optionally, the voltage dividing unit 21 includes a fourth voltage dividing resistor R141 and a fifth voltage dividing resistor R160. The first voltage stabilizing unit 22 includes a voltage stabilizer diode D25. The fourth voltage dividing resistor R141 and the fifth voltage dividing resistor R160 are sequentially connected in series between an output terminal of the voltage conversion circuit 10 and the second terminal b2 of the switch 23. A terminal of the voltage stabilizer diode D25 is connected between the fourth voltage dividing resistor R141 and the fifth voltage dividing resistor R160, and another terminal of the voltage stabilizer diode D25 is connected to a control terminal B3 of the switch 23. The first terminal b1 of the switch 23 is connected to an input terminal of the first optical coupler U10 and/or an input terminal of the second optical coupler U3. The second terminal b2 of the switch 23 is grounded.

In conjunction with FIGS. 3 and 6, specifically, the switch 23 may be a transistor which can amplify a weak electrical signal into an electrical signal with a large amplitude. The switch 23 includes any of a bipolar transistor, a field effect transistor and a metal oxide semiconductor field effect transistor, etc. The fourth voltage dividing resistor R141 and the fifth voltage dividing resistor R160 can sample and divide the output voltage of the second output terminal B2. If the voltage outputted to the voltage stabilizer diode D25 after the voltage division is greater than a reverse breakdown voltage of the voltage stabilizer diode D25, then the voltage stabilizer diode D25 is turned on reversely, and the switch 23 is turned on after the control terminal b3 receives the voltage signal, so that the potential at the first terminal b1 the switch 23 is changed, the switch 23 outputs the control signal through the first terminal b1 to the input terminal of the first optical coupler U10 and/or the input terminal of the second optical coupler U3, to control the main loop circuit 11 through the first optical coupler U10 and/or the second optical coupler U3 to stop outputting the voltage.

Referring to FIG. 6, optionally, the overvoltage protection circuit 20 further includes a fourth current-limiting resistor R162 and a first protective resistor R161. The fourth current-limiting resistor R162 is connected between the voltage stabilizer diode D25 and the control terminal b3 of the switch 23. The first protective resistor R161 is connected in series between the voltage stabilizer diode D25 and the second terminal b2 of the switch 23. The fourth current-limiting resistor R162 is configured to limit current, and the first protective resistor R161 is configured to protect the circuit to prevent the switch 23 from malfunctioning.

Exemplarily, the working principle for overvoltage protection of the power adapter will be further explained by referring to FIGS. 3 to 6 and combining specific examples. For example, the output voltage of the second output terminal B2 is 21V, the resistance of R141 is 33 kilohms, the resistance of R160 is 13 kilohms, the reverse breakdown voltage of D25 is 6.8V, the resistance of R161 is 510 kilohms, and the resistance of R162 is 1 kilohms. The setting voltage used for activating the protective protection may be set as 26.5 V. When the fourth voltage dividing resistor R141 and the fifth voltage dividing resistor R160 detect that the output voltage of the second output terminal B2 is greater than 26.5 V, the voltage value across R160 is 6.8V+Vbe, where Vbe is the turning-on voltage value of the switch 23. At this time, the voltage stabilizer diode D25 would be turned on, so that the switch 23 is turned on. Thus, the switch 23 outputs the control signal C1 through the first terminal b1 to the input terminal of the first optical coupler U10 or the input terminal of the second optical coupler U3, to enable the first optical coupler U10 or the second optical coupler U3 to work. In this case, the control signal is outputted through the first optical coupler U10 and the first control chip 121 to the main loop circuit 11, or the control signal is outputted through the second optical coupler U3 and the second control chip 131, so as to control the main loop circuit 11 stops outputting the voltage, thereby achieving the overvoltage protection.

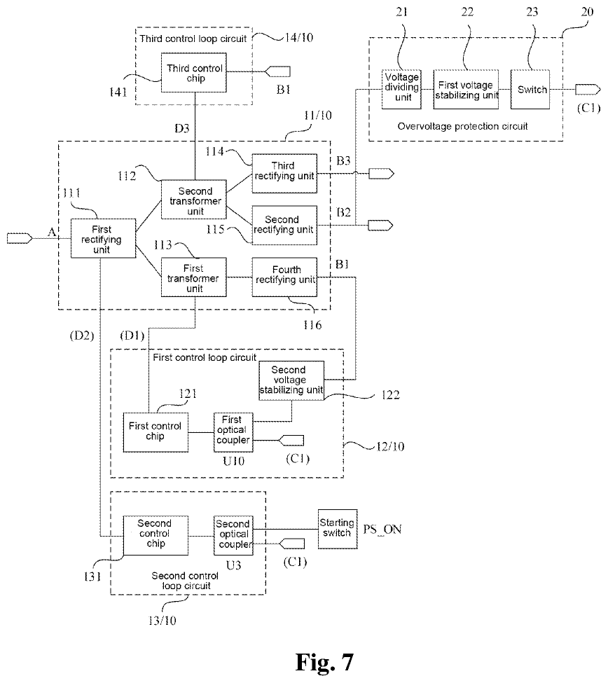

FIG. 7 is a schematic diagram of circuit configurations of another power adapter according to an embodiment of the present disclosure. As shown in FIG. 7, optionally, the voltage conversion circuit 10 includes three output terminals, where the three output terminals output DC voltages with different levels, and the overvoltage protection circuit 20 is connected to any of the three output terminals in a one-to-one correspondence. FIG. 7 exemplarily shows the connection configuration between the overvoltage protection circuit 20 and the second output terminal B2. However, in practice, each of the output terminals may be provided with an overvoltage protection circuit 20, or some of the output terminals may be provided with overvoltage protection circuits 20, respectively, to achieve the overvoltage protection for the multi-output power adapter.

Referring to FIG. 7, optionally, the main loop circuit 11 includes a first rectifying unit 111, a first transformer unit 113, a second transformer unit 112, a second rectifying unit 115, a third rectifying unit 114 and a fourth rectifying unit 116. The first rectifying unit 111 is configured to rectify an AC inputted via the input terminal A to a DC and then output the DC to the first transformer unit 113 and the second transformer unit 112. The input power is transformed by the first transformer unit 113 and then rectified by the four rectifying unit 116, and then the rectified power is outputted to the first output terminal B1; also, the input power is transformed by the second transformer unit 112 and then rectified by the second rectifying unit 115, and then the rectified power is outputted to the second output terminal B2; also, the input power is transformed by the second transformer unit 112 and then rectified by the third rectifying unit 114, and then the rectified power is outputted to the third output terminal B3. Exemplarily, The AC inputted via the input terminal A may be a 220V. In this case, the first rectifying unit 111 is configured to rectify and step up the 220V AC to a 380V DC. Next, the 380V DC is stepped down and rectified by first transformer unit 113 and the fourth rectifying unit 116 to a 12V DC, and then is outputted via the first output terminal B1; also, the 380V DC is stepped down and rectified by the second transformer unit 112 and the second rectifying unit 115 to a 21V DC, and then is outputted via the second output terminal B2; also, the 380V DC is stepped down and rectified by the second transformer unit 112 and the third rectifying unit 114 to a 28V DC, and then is outputted via the third output terminal B3. Since the voltage level of the second output terminal is close to that of the third output terminal, the third rectifying unit 114 and the fourth rectifying unit 116 may share the second transformer unit 112.

Referring to FIG. 7, optionally, the first transformer unit 113 and the fourth rectifying unit 116 may constitute a flyback converter, and accordingly, the first control chip 121 may be a flyback control chip. The first control chip 121 may control the output voltage of the main loop circuit 11 by controlling the first transformer unit 113. The second control chip 131 may be a power factor correction controlling chip, and may control the output voltage of the main loop circuit 11 by controlling the first rectifying unit 111. The voltage conversion circuit 10 further includes a third control circuit 14 provided with a third control chip 141. The third control chip 141 is electrically connected to the second transformer unit 112. The third control chip 141 may be a resonance control chip, and may control the output voltage of the main loop circuit 11 by controlling the second transformer unit 112. The voltage conversion circuit 10 outputs the voltage via the first output terminal B1 to supply the power to the first control chip 121, the second control chip 131 and the third control chip 141.

Exemplarily, with reference to FIG. 7, when the overvoltage at the second output terminal B2 is detected by the overvoltage protection circuit 20, the overvoltage protection circuit 20 may output the control signal C1 to the second optical coupler U3 through the switch 23, so that the second optical coupler U3 may output a signal to the first rectifier unit 111 through the second control chip 131, and then the first rectifier unit stops the subsequent voltage conversion in order to directly control the three output terminal to stop outputting the voltage; or, the overvoltage protection circuit 20 may output the control signal C1 through the switch 23 to the first optical coupler U10, so that the first optical coupler U10 may output a signal to the first transformer unit 113 through the first control chip 121, and then the first transformer unit 113 controls the first output terminal B1 to stop outputting the voltage. In this way, the second control chip 131 and the third control chip 141 would not continue to work due to the loss of voltage source. Without being controlled, the first rectifier unit 111, the first transformer unit 113 and the second transformer unit 112 would not be worked, so that the three output terminals of the voltage converter circuit 10 stops outputting the voltage, thereby achieving the overvoltage protection.

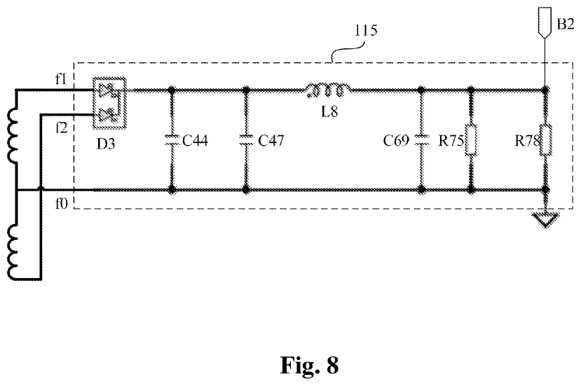

FIG. 8 is a schematic diagram of circuit configurations of the second rectifying unit 115 in FIG. 7. In conjunction with FIGS. 7 and 8, optionally, the second rectifying unit 115 includes a rectifier D3, a filtering capacitor C44, a filtering capacitor C47, a filtering inductor L8, a filtering capacitor C69, a load resistor R75 and a load resistor R78. Specifically, the rectifier D3 includes an input terminal f1, an input terminal f2 and an input terminal f0. The input terminal f1 and the input terminal f2 may be connected to two windings of the secondary side of a transformer of the second transformer unit 112, respectively. The input terminal f0 may be connected to a neutral point of the transformer. The rectifier D3 is configured to rectify the input voltage transformed by the second transformer unit 112, to change the input voltage into the corresponding voltage level. The rectifier D3 is implemented in the form of two diodes connected in parallel, with the two diodes sharing and converting the electric energy on the two input terminals. As compared to the manner of using only one rectifier diode for rectification, the manner of using two diodes can prevent the diode from being damaged due to the two large input voltage.

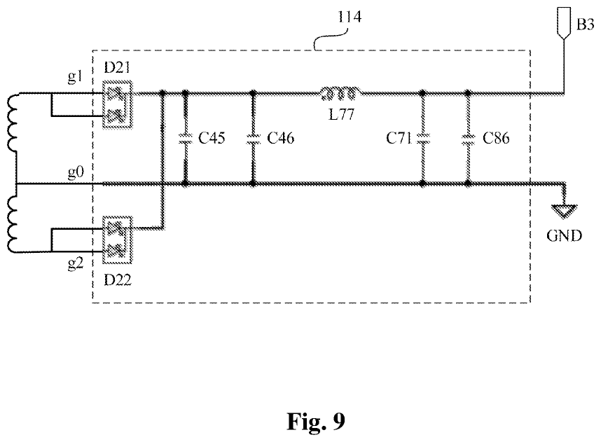

FIG. 9 is a schematic diagram of circuit configurations of the third rectifying unit 114 in FIG. 7. In conjunction with FIGS. 7 and 9, optionally, the third rectifying unit 114 includes a rectifier D21, a rectifier D22, a filtering capacitor C45, a filtering capacitor C46, a filtering inductor L77, a filtering capacitor C71 and a filtering capacitor C86. Specifically, the third rectifier unit 114 includes an input terminal g0-g2, where the input terminal g1 may be connected to a winding of a transformer of the second transformer unit 112, the input terminal G2 may be connected to another winding of the transformer, and the input terminal g0 may be connect a neutral point of the transformer. When the output voltage of the third output terminal B3 is greater than the output voltage of the second output terminal B2, both the rectifier D21 and the rectifier D22 may be provides as the form of two diodes connected in parallel. The two diodes of the rectifier D21 share the electric energy at the input terminal g1 and the two diodes of the rectifier D22 share the electric energy at the input terminal g2, so that the rectifier D21 and the rectifier D22 can jointly perform the electric energy conversion, thereby preventing the diode from being damaged due to the two large input voltage.

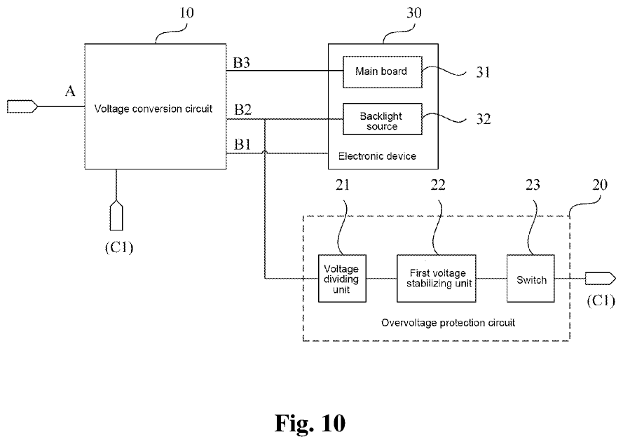

An embodiment of the present disclosure also provides an electronic device. FIG. 10 is a schematic diagram of block configurations of an electronic device according to an embodiment of the present disclosure. As shown in FIG. 10, the electronic device 30 is powered by the power adaptor according to the embodiments of the present disclosure. The electronic device as provided by the embodiments of the present disclosure includes the power adapter according to the above embodiments, thus having respective functional modules and benefits of the power adapter, which is not repeated here.

Optionally, referring to FIG. 10, the electronic device may be such as a television or a computer. FIG. 10 schematically illustrates an example that an electronic device 30 is a crystal-liquid television and the power adapter has three output terminals. The electronic device may include a main board 31 and a backlight source 32. When the electronic device is in standby mode, the electronic device may be powered by the first output terminal B1; and when the electronic device is in a normal operating mode, the backlight source 32 may be powered by the second output terminal B2 and the main board 31 may be powered by the third output terminal. The electronic device as provided by the embodiments of the present disclosure includes the power adapter according to the above embodiments, thus having respective functional modules and benefits of the power adapter, which is not repeated here.

Although some embodiments and the applied technology principles of the present disclosure have been described as above, it should be understood by those skilled in the art that the present disclosure is not limited to particular embodiments described herein. Various modifications, readjustment and alternations can be made by those skilled in the art without departing the scope of protection of the present disclosure, and these modifications, readjustment and alternations fall within the scope of the present disclosure which is subject to the appended claims.

What is claimed is:

1. A power adapter, comprising:
a voltage conversion circuit comprising an input terminal and at least two output terminals, wherein the voltage conversion circuit is configured to perform a conversion operation on a voltage inputted by via the input terminal and then output direct-current (DC) voltages from the at least two output terminals, wherein the DC voltages outputted from the at least two output terminals have different levels; and
at least one overvoltage protection circuit, comprising a voltage dividing unit, a first voltage stabilizing unit and a switch, wherein the voltage dividing unit is connected between a first output terminal (B2) of the at least two output terminals of the voltage conversion circuit and the first voltage stabilizing unit, and the first voltage stabilizing unit is connected to the switch,
wherein the overvoltage protection circuit is configured such that, when the voltage divided and subsequently outputted by the voltage dividing unit is greater than a setting voltage, the first voltage stabilizing unit controls the switch to be turned on to output a control signal through the switch to the voltage conversion circuit, in order to control the first output terminal (B2) of the at least two output terminals of the voltage conversion circuit to stop an outputting operation.

2. The power adapter according to claim 1, wherein the voltage conversion circuit comprises a main loop circuit and a first control loop circuit;
wherein the main loop circuit is connected between the input terminal and the at least two output terminals of the voltage conversion circuit; and
the first control loop circuit is connected between the main loop circuit and a second output terminal (B1) of the at least two output terminals of the voltage conversion circuit, a first optical coupler is connected in series on the first control loop circuit, the switch is connected to one of two input terminals of the first optical coupler, and the switch controls via the first optical coupler whether the main loop circuit stops the outputting operation,
wherein the first output terminal (B2) and the second output terminal (B1) are same output terminal or different output terminals.

3. The power adapter according to claim 2, wherein the voltage conversion circuit further comprises a second control loop circuit;
wherein the second control loop circuit is connected between the main loop circuit and a starting switch, a second optical coupler is serially connected on the second control loop circuit, the switch is connected to one of two input terminals of the second optical coupler, and the switch controls via the second optical coupler whether the main loop circuit stops the outputting operation.

4. The power adapter according to claim 2, wherein the first control loop circuit further comprises a first control chip and a second voltage stabilizing unit;
wherein the first control chip is connected between the main loop circuit and the first optical coupler, the second voltage stabilizing unit is connected between the first optical coupler and the second output terminal (B1) of the at least two output terminals of the voltage conversion circuit, and the first optical coupler controls via the first control chip whether the main loop circuit stops the outputting operation; and
the second voltage stabilizing unit is configured to control via the first optical coupler and the first control chip whether the main loop circuit stops the outputting operation, when the voltage outputted from the output terminal of the voltage conversion circuit is unstable.

5. The power adapter according to claim 4, wherein
the second voltage stabilizing unit comprises a first current-limiting resistor, a second current-limiting resistor, a first voltage stabilizer, a loop circuit compensator, a first voltage dividing resistor, a second voltage dividing resistor and an output voltage regulator;
wherein the first current-limiting resistor and the second current-limiting resistor are sequentially connected in series between the second output terminal (B1) of the at least two output terminals of the voltage conversion circuit and a first terminal of the first voltage stabilizer, another one of the two input terminals of the first optical coupler is connected between the first current-limiting resistor and the second current-limiting resistor, the one of the two input terminals of the first optical coupler is connected between the second current-limiting resistor and the first terminal of the first voltage stabilizer, a loop circuit compensator is connected between the first terminal of the first voltage stabilizer and a reference terminal of the first voltage stabilizer, the first voltage dividing resistor and the second voltage dividing resistor are sequentially connected in series between the second output terminal (B1) of the at least two output terminals of the voltage conversion circuit and a second terminal of the first voltage stabilizer, the reference terminal of the first voltage stabilizer is connected to between the first voltage dividing resistor and the second voltage dividing resistor, the second terminal of the first voltage stabilizer is grounded, and the output voltage regulator is connected in parallel to the first voltage dividing resistor.

6. The power adapter according to claim 3, wherein the second control loop circuit further comprises a second control chip, a third current-limiting resistor and the third voltage dividing resistor;
wherein the second control chip is connected between the main loop circuit and the second optical coupler, and the third current-limiting resistor is connected in series between the starting switch and the one of the two input terminals of the second optical coupler, the third voltage dividing resistor connected in parallel between the two input terminals of the second optical coupler, and the second optical coupler controls via the second control chip whether the main loop circuit stops the outputting operation.

7. The power adapter according to claim 3, wherein the voltage dividing unit comprises a fourth voltage dividing resistor and a fifth voltage dividing resistor, and the first voltage stabilizing unit comprises a voltage stabilizer diode;
wherein the fourth voltage dividing resistor and the fifth voltage dividing resistor are sequentially connected in series between the first output terminal (B2) of the at least two output terminals of the voltage conversion circuit and a second terminal of the switch, a terminal of the voltage stabilizer diode is connected between the fourth voltage dividing resistor and the fifth voltage dividing resistor, another terminal of the voltage stabilizer diode is connected to a control terminal of the switch, the first terminal of the switch is connected to the one of the two input terminals of the first optical coupler and/or the one of the two input terminals of the second optical coupler, and a second terminal of the switch is grounded.

8. The power adapter according to claim 7, wherein the overvoltage protection circuit further comprises a fourth current-limiting resistor and a first protective resistor;
wherein the fourth current-limiting resistor is connected between the voltage stabilizer diode and the control terminal of the switch, and the first protective resistor is connected in series between the voltage stabilizer diode and the second terminal of the switch.

9. The power adapter according to claim 1, wherein the voltage conversion circuit comprises three output terminals, the three output terminals output different levels of the DC voltages from each other, and
when the at least one overvoltage protection circuit comprises one overvoltage protection circuit, the one overvoltage protection circuit is connected to any one of the three output terminals, and
when the at least one overvoltage protection circuit comprises a plurality of overvoltage protection circuits, the plurality of overvoltage protection circuit are connected to more of the three output terminals in a one-to-one correspondence, respectively.

10. An electronic device, which is powered by a power adapter, wherein the power adapter comprises:
a voltage conversion circuit comprising an input terminal and at least two output terminals, wherein the voltage conversion circuit is configured to perform a conversion operation on a voltage inputted by via the input terminal and then output direct-current (DC) voltages from the at least two output terminals, wherein the DC voltages outputted from the at least two output terminals have different levels; and
at least one overvoltage protection circuit, comprising a voltage dividing unit, a first voltage stabilizing unit and a switch, wherein the voltage dividing unit is connected between a first output terminal (B2) of the at least two output terminals of the voltage conversion circuit and the first voltage stabilizing unit, and the first voltage stabilizing unit is connected to the switch,
wherein the overvoltage protection circuit is configured such that, when the voltage divided and subsequently outputted by the voltage dividing unit is greater than a setting voltage, the first voltage stabilizing unit controls the switch to be turned on to output a control signal through the switch to the voltage conversion circuit, in order to control the first output terminal (B2) of the at least two output terminals of the voltage conversion circuit to stop an outputting operation.

11. The electronic device according to claim 10, wherein the voltage conversion circuit comprises a main loop circuit and a first control loop circuit;
wherein the main loop circuit is connected between the input terminal and the at least two output terminals of the voltage conversion circuit; and
the first control loop circuit is connected between the main loop circuit and a second output terminal (B1) of the at least two output terminals of the voltage conversion circuit, a first optical coupler is connected in series on the first control loop circuit, the switch is connected to one of two input terminals of the first optical coupler, and the switch controls via the first optical coupler whether the main loop circuit stops the outputting operation,
wherein the first output terminal (B2) and the second output terminal (B1) are same output terminal or different output terminals.

12. The electronic device according to claim 11, wherein the voltage conversion circuit further comprises a second control loop circuit;
wherein the second control loop circuit is connected between the main loop circuit and a starting switch, a second optical coupler is serially connected on the second control loop circuit, the switch is connected to one of two input terminals of the second optical coupler, and the switch controls via the second optical coupler whether the main loop circuit stops the outputting operation.

13. The electronic device according to claim 11, wherein the first control loop circuit further comprises a first control chip and a second voltage stabilizing unit;
wherein the first control chip is connected between the main loop circuit and the first optical coupler, the second voltage stabilizing unit is connected between the first optical coupler and the second output terminal (B1) of the at least two output terminals of the voltage conversion circuit, and the first optical coupler controls via the first control chip whether the main loop circuit stops the outputting operation; and
the second voltage stabilizing unit is configured to control via the first optical coupler and the first control chip whether the main loop circuit stops the outputting operation, when the voltage outputted from the output terminal of the voltage conversion circuit is unstable.

14. The electronic device according to claim 13, wherein
the second voltage stabilizing unit comprises a first current-limiting resistor, a second current-limiting resistor, a first voltage stabilizer, a loop circuit compensator, a first voltage dividing resistor, a second voltage dividing resistor and an output voltage regulator;
wherein the first current-limiting resistor and the second current-limiting resistor are sequentially connected in series between the second output terminal (B1) of the at least two output terminals of the voltage conversion circuit and a first terminal of the first voltage stabilizer, another one of the two input terminals of the first optical coupler is connected between the first current-limiting resistor and the second current-limiting resistor, the one of the two input terminals of the first optical coupler is connected between the second current-limiting resistor and the first terminal of the first voltage stabilizer, a loop circuit compensator is connected between the first terminal of the first voltage stabilizer and a reference terminal of the first voltage stabilizer, the first voltage dividing resistor and the second voltage dividing resistor are sequentially connected in series between the second output terminal (B1) of the at least two output terminals of the voltage conversion circuit and a second terminal of the first voltage stabilizer, the reference terminal of the first voltage stabilizer is connected to between the first voltage dividing resistor and the second voltage dividing resistor, the second terminal of the first voltage stabilizer is grounded, and the output voltage regulator is connected in parallel to the first voltage dividing resistor.

15. The electronic device according to claim 12, wherein the second control loop circuit further comprises a second control chip, a third current-limiting resistor and the third voltage dividing resistor;
wherein the second control chip is connected between the main loop circuit and the second optical coupler, and the third current-limiting resistor is connected in series between the starting switch and the one of the two input terminals of the second optical coupler, the third voltage dividing resistor connected in parallel between the two input terminals of the second optical coupler, and the second optical coupler controls via the second control chip whether the main loop circuit stops the outputting operation.

16. The electronic device according to claim 12, wherein the voltage dividing unit comprises a fourth voltage dividing resistor and a fifth voltage dividing resistor, and the first voltage stabilizing unit comprises a voltage stabilizer diode;
wherein the fourth voltage dividing resistor and the fifth voltage dividing resistor are sequentially connected in series between the first output terminal (B2) of the at least two output terminals of the voltage conversion circuit and a second terminal of the switch, a terminal of the voltage stabilizer diode is connected between the fourth voltage dividing resistor and the fifth voltage dividing resistor, another terminal of the voltage stabilizer diode is connected to a control terminal of the switch, the first terminal of the switch is connected to the one of the two input terminals of the first optical coupler and/or the one of the two input terminals of the second optical coupler, and a second terminal of the switch is grounded.

17. The electronic device according to claim 16, wherein the overvoltage protection circuit further comprises a fourth current-limiting resistor and a first protective resistor;
wherein the fourth current-limiting resistor is connected between the voltage stabilizer diode and the control terminal of the switch, and the first protective resistor is connected in series between the voltage stabilizer diode and the second terminal of the switch.

18. The electronic device according to claim 10, wherein the voltage conversion circuit comprises three output terminals, the three output terminals output different levels of the DC voltages from each other, and
when the at least one overvoltage protection circuit comprises one overvoltage protection circuit, the one overvoltage protection circuit is connected to any one of the three output terminals, and
when the at least one overvoltage protection circuit comprises a plurality of overvoltage protection circuits, the plurality of overvoltage protection circuit are connected to more of the three output terminals in a one-to-one correspondence, respectively.
